(19) United States
(12) Patent Application Publication
(10) Pub. No.: US 2024/0430937 A1
(43) Pub. Date: Dec. 26, 2024

(54) A Coordinating Wireless Device, A Network Node, A Wireless Device and Methods Therein for Enabling Uplink, UL, Transmissions in a Wireless Communications Network

(71) Applicant: Telefonaktiebolaget LM Ericsson (publ), Stockholm (SE)

(72) Inventors: Mårten Ericson, Gammelstad (SE); Min Wang, Luleå (SE); Stefan Wänstedt, Luleå (SE); Jan Christoffersson, Luleå (SE)

(21) Appl. No.: 18/274,065

(22) PCT Filed: Jan. 27, 2021
(86) PCT No.: PCT/SE2021/050049

§ 371 Date: Jul. 25, 2023

(51) Int. Cl. H04W 74/0833; H04W 72/21

(52) U.S. Cl. CPC H04W 74/0833; H04W 72/21

(57) ABSTRACT

A method performed by a coordinating wireless device (121) and a coordinating wireless device for enabling a group of wireless devices (131) to perform uplink, UL, transmissions towards a network node (110) in a wireless communications network (100) is provided. The coordinating wireless device receives, from the network node, information configuring the coordinating wireless device to handle Random Access, RA, using Sidelink, SL, resources towards wireless devices in the group of wireless devices. Also, the coordinating wireless device transmits, to the wireless devices in the group of wireless devices on SL resources, information for use by the wireless devices in the group of wireless devices to perform RA using SL resources towards the coordinating wireless device. Corresponding methods performed by a network node and a wireless device (122), as well as, a network node and a wireless device are also provided.

### TECHNICAL FIELD

Embodiments herein relate to enabling uplink, UL, transmissions in a wireless communications network. In particular, embodiments herein relate to a coordinating wireless device and method therein for enabling a group of wireless devices to perform UL transmissions towards a network node in a wireless communications network. Also, embodiments herein relate to a network node and method therein for enabling a group of wireless devices to perform UL transmissions towards a network node in a wireless communications network. Further, the embodiments herein also relate to a wireless device and method therein for enabling an UL transmission towards a network node in a wireless communications network.

### BACKGROUND

In today's wireless communications networks a number of different technologies are used, such as New Radio (NR), Long Term Evolution (LTE), LTE-Advanced, Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few possible technologies for wireless communication. A wireless communications network comprises network nodes, e.g. eNB/gNBs, radio base stations, wireless access points, etc., providing radio coverage over at least one respective geographical area forming a cell. This may be referred to as a Radio Access Network, RAN. The cell definition may also incorporate frequency bands used for transmissions, which means that two different cells may cover the same geographical area but using different frequency bands. Wireless devices, also referred to herein as User Equipments, UEs, mobile stations, and/or wireless terminals, are served in the cells by the respective network node and are communicating with respective network node in the RAN. Commonly, the wireless devices transmit data over an air or radio interface to the network nodes in uplink, UL, transmissions and the network nodes transmit data over an air or radio interface to the wireless devices in downlink, DL, transmissions.

FIG. 1 describes an example of a 4-step initial approach of a Random Access, RA, or Random Access Channel, RACH, procedure in NR release 15. In this approach, the UE may in Action 101a detect a Synchronization Signal, SS. This may, for example, be a SSB or SS-block comprising a New Radio Primary SS, NR PSS, a NR Secondary SS, NR SSS, and a NR Physical Broadcast Channel, NR PBCH. In Action 101b, the UE may decode the broadcasted system information, such as, e.g. NR Remaining Minimum System Information, RMSI, and Other System Information, OSI. This may be followed in Action 102 by the UE transmitting a Physical RACH, PRACH, preamble in the uplink, e.g. NR-PRACH. This PRACH preamble message may also be referred to as message 1 or Msg1. In Action 103, the gNB may reply with a Random Access Response, RAR, e.g. NR-RAR. This RAR message may also be referred to as message 2 or Msg2. The UE may then in Action 104 transmit a UE identification on a PUSCH, Physical Uplink Shared Channel, using an uplink grant, i.e. an allocation of uplink transmission resources. The UE transmits PUSCH, also referred to as message 3 or Msg3, after receiving a Timing Advance, TA, command in the RAR. This allows PUSCH to be received with a timing accuracy within the Cyclic Prefix, CP. Without this timing advance, a very large Cyclic Prefix, CP, would be needed in order to be able to demodulate and detect PUSCH, unless the system is applied in a cell with very small distance between UE and gNB. Since NR will also support larger cells with a need for providing a timing advance to the UE, the 4-step approach is needed for the random access procedure. To conclude this 4-step approach of RA, the gNB may, in Action 105, transmit a Contention Resolution Message, CRM, comprising a contention resolution ID to the UE. The contention resolution ID allows the UE to be informed that it has been correctly identified by the gNB in the wireless communications network.

In the above RA procedure, the UE will indicate a Synchronization Signal Block, SSB, to inform the gNB about in which direction to transmit the RAR and subsequent messages. The SSB selection by the UE may be done by comparing the SS-RSRP, SS-Reference Signal Received Power, to a threshold value, i.e. rsrp-ThresholdSSB. For contention-based RA, the SSB selection may be performed as defined in the 3GPP Technical Specification, TS, 38.321, incorporated herein by reference. Once the SSB has been selected, the indication to the gNB may be done by selection of preamble and/or PRACH occasion, RO, depending on the configuration. With the use of specific preambles and/or RO, the UE implicitly indicates the selected SSB to the gNB.

In one extreme configuration, the indication is done purely by the preamble meaning that the preamble index will indicate the SSB irrespectively on which RO it is transmitted. In another extreme, the RO alone will indicate the SSB, irrespectively of preamble index. In a typical case, the indication will be a combination of these extremes, such as, for example, depending on which RO, the preamble index will indicate the SSB. This means that a certain preamble index will indicate different SSBs depending on in which RO it is transmitted.

Here, it should be noted that the available number of SSBs (up to 64) will impact how the configuration of the resources is done. It may also be observed that for a high number of available SSBs, indicating using only the preamble index is not sufficient. This is because preamble indices will also be needed also for contention-free RA and SI requests. When several ROs are needed to indicate SSB, the latency of the RA procedure will increase, or alternatively give a large overhead in terms of configured ROs. Hence, when the number of available SSBs is high, preambles and ROs will be a scarce resource and the RA configuration will have to balance the overhead in terms of PRACH resources with the latency and allocation of preambles to other things than SSB indication.

For Contention-Free RA, CFRA, resources may be assigned to UEs in connected mode. This means that the UE already has a C-RNTI and in most cases also a UL time alignment. In case of CFRA, the SSBs are indicated either by ROs or preambles which means that the preamble usage may be higher than, for example, in LTE. In LTE, only one preamble needs to be dedicated to give CFRA resources to a UE, while in NR the number of preambles is equal to the number of SSBs that needs to be indicated per RO. Since the UE is in connected mode, beam management algorithms ensure that the gNB in many cases already knows which beam is best for the UE.

FIG. 2 describes an example of a 2-step initial approach of a RA or RACH procedure in NR Release 16. Actions 401a-401b are similar to the corresponding actions 101a-101b described in FIG. 1. In this approach, the UE may in Action 402a send a message A or Msg A comprising a random access preamble. This Msg A transmission may be performed together with the transmission of higher layer data, such as, a RRC connection request possibly with some small payload on PUSCH in Action 402b. The MsgA PUSCH may be used for small data transmissions in inactive mode. Then, the gNB may in Action 403 send a response message called message B or MsgB comprising, for example, a UE identifier assignment, timing advance information, and contention resolution message, etc. In addition, the MsgB may also comprise a higher layer part. Similar to a RAR, the MsgB may further comprise responses to multiple MsgAs, and thus to multiple UEs, but the optional higher layer part can only pertain to one of the responses, i.e. to one of the MsgAs/UEs. If a response in a MsgB does not have an associated higher layer part, this will be sent in a separate subsequent message, e.g. an RRC message, on the PDSCH. The MsgB is a response to MsgA, which may comprise contention resolution message(s), fallback indication(s) to schedule Msg3 transmission, and a back-off indication. The MsgA may also comprise responses to multiple UEs and with different kinds of information for different UEs depending on the outcome of the MsgA transmission and reception, and also the load on the access resources.

Upon a successful MsgA reception, the gNB may include a successRAR MAC subPDU as a response for the concerned UE, where the successRAR MAC subPDU includes a contention resolution identity, a timing advance and a C-RNTI allocation. If the gNB successfully received the RACH preamble, but failed to receive msgA PUSCH, the gNB may respond to the concerned UE with a fallbackRAR MAC subPDU in the msgB. The fallbackRAR essentially turns the two-step RA into a four-step RA and consequently the fallbackRAR MAC subPDU comprises an UL grant, a timing advance and a temporary C-RNTI, TC-RNTI, allocation, but no contention resolution identity. Then, the UE use the UL grant to retransmit MsgA PUSCH in the form of Msg3. In addition to successRAR and fallbackRAR MAC subPDUs, the gNB may include a parameter which is intended for the UEs that did not find any response to their respective MsgA transmissions in MsgB. This parameter is the back-off Indicator, e.g. a single parameter for all UEs which did not find their expected response in the MsgB. The back-off indicator may control whether and how much a UE must wait until it can attempt to access the network through random access again.

In the above procedures, the system information for RA, that is, the RACH configurations parameters needed for the UE to initiate the random access, is comprised in the System Information Block 1, SIB1. In order to read the SIB1, the UE must first read the MIB. This may be performed as defined in the 3GPP Technical Specification, TS, 38.331, section 5.2.1, incorporated herein by reference.

However, one problem with the current RA procedure described above is that it is resource consuming. This is because the time and frequency resources assigned to RA must be configured to be able to handle a high load, i.e. a larger number of UE attempting RA. For example, assume a scenario where a large number of UEs are present in a cell, where each UE makes a RA attempt in order to enter a RRC_CONNECTED state and then sends a small burst of small packets after which the UE goes back to an RRC_INACTIVE/IDLE. This is common, for example, within IoT or normal chatty social media services. This may cause the RA to be a bottleneck for the UEs in achieving cell resources and sending the data. Thus, several RA attempts may be needed by a UE to access the gNB successfully, which may cause long delays and also interference. To overcome this, the gNB may over-provision the cell resources assigned to RA attempts. However, this naturally comes at an expense of normal cell resources. Also, if contention-free RA is used, it is also very resource consuming, since each UE is assigned a preamble. Contention-free RA is only available in connected mode in NR and LTE. A reason that it is difficult for the gNB to optimally assign resources to RA attempts is of course that it is impossible to exactly estimate the number of UEs that will be using the cell resources assigned to RA attempts at a given time. Thus, the gNB must either rely on overprovisioning, which is resource heavy, or let UE perform several RA attempts, which causes long delays and latency. Hence, there is a need to improve random access in a wireless communications network.

### SUMMARY

It is an object of embodiments herein to improve random access in a wireless communications network.

According to a first aspect of embodiments herein, the object is achieved by a method performed by a coordinating wireless device for enabling a group of wireless devices to perform uplink, UL, transmissions towards a network node in a wireless communications network. The method comprises receiving, from the network node, information configuring the coordinating wireless device to handle Random Access, RA, using Sidelink, SL, resources towards wireless devices in the group of wireless devices. The method also comprises transmitting, to the wireless devices in the group of wireless devices on SL resources, information for use by the wireless devices in the group of wireless devices to perform RA using SL resources towards the coordinating wireless device.

According to a second aspect of embodiments herein, the object is achieved by a coordinating wireless device for enabling a group of wireless devices to perform UL transmissions towards a network node in a wireless communications network. The coordinating wireless device is configured to receive, from the network node, information configuring the coordinating wireless device to handle RA using SL resources towards wireless devices in the group of wireless devices. Also, the coordinating wireless device is configured to transmit, to the wireless devices in the group of wireless devices on SL resources, information for use by the wireless devices in the group of wireless devices to perform RA using SL resources towards the coordinating wireless device.

According to a third aspect of embodiments herein, the object is achieved by a method performed by a network node for enabling a group of wireless devices to perform UL transmissions towards the network node in a wireless communications network. The method comprises transmitting, to a coordinating wireless device, information configuring the coordinating wireless device to handle RA using SL resources towards wireless devices in a group of wireless devices associated with the coordinating wireless device. The method also comprises transmitting, to the wireless devices in the group of wireless devices, information configuring the wireless devices in the group of wireless devices to perform RA using SL resources towards the coordinating wireless device.

According to a fourth aspect of embodiments herein, the object is achieved by a network node for enabling a group of wireless devices to perform UL transmissions towards the network node in a wireless communications network. The network node is configured to transmit, to a coordinating wireless device, information configuring the coordinating wireless device to handle RA using SL resources towards wireless devices in a group of wireless devices associated with the coordinating wireless device. The network node is also configured to transmit, to the wireless devices in the group of wireless devices, information configuring the wireless devices in the group of wireless devices to perform RA using SL resources towards the coordinating wireless device.

According to a fifth aspect of embodiments herein, the object is achieved by a method performed by a wireless device for enabling UL transmissions towards a network node in a wireless communications network. The method comprises receiving, from the network node, information configuring the wireless device to perform RA using SL resources towards a coordinating wireless device associated with the wireless device. The method also comprises receiving, from the coordinating wireless device on SL resources, information for use by the wireless device to perform RA using SL resources towards the coordinating wireless device.

According to a sixth aspect of embodiments herein, the object is achieved by a wireless device for enabling UL transmissions towards a network node in a wireless communications network. The wireless device is configured to receive, from the network node, information configuring the wireless device to perform RA using SL resources towards a coordinating wireless device associated with the wireless device. Also, the wireless device is configured to receive, from the coordinating wireless device on SL resources, information for use by the wireless device to perform RA using SL resources towards the coordinating wireless device.

According to a seventh aspect of the embodiments herein, a computer program is also provided configured to perform the method described above. Further, according to an eight aspect of the embodiments herein, carriers are also provided configured to carry the computer program configured for performing the method described above.

By enabling coordinating wireless devices that are arranged to coordinate and communicate with groups of wireless devices over SL and schedule UL transmissions from the groups of wireless devices based on group configured grants from a network node to also handle the RA attempts from the groups of wireless devices over SL as described above, faster RA attempts and lower power consumption of the wireless devices will be achieved. This is because the collision probability of RA preamble transmissions will be reduced, due to the limited number of wireless devices within each group of wireless devices, while the close proximity to the coordinating wireless device also will lead to fewer re-transmissions from the wireless devices and thus to less power being needed. Additionally, on the network side, the amount of resources required for RA attempts from the total number of wireless devices served by the network node may be significantly reduced. This is because the network node may re-use resources and preambles for different groups of wireless devices that are sufficiently spatially separated. Consequently, this will lead to an increased RA capacity and reduce delay for RA of the wireless devices in the wireless communications network. Hence, random access in the wireless communications network is improved.

### BRIEF DESCRIPTION OF THE DRAWINGS

Features and advantages of the embodiments will become readily apparent to those skilled in the art by the following detailed description of exemplary embodiments thereof with reference to the accompanying drawings, wherein:

FIG. 1 is a signalling diagram illustrating a four-step RA procedure,

FIG. 2 is a signalling diagram illustrating a two-step RA procedure,

FIG. 3 is a schematic block diagram of a wireless communications network,

FIG. 4 is a flowchart depicting embodiments of a method in a coordinating wireless device,

FIG. 5 is a flowchart depicting embodiments of a method in a network node,

FIG. 6 is a flowchart depicting embodiments of a method in a wireless device,

FIG. 7 is a signalling diagram illustrating embodiments of a coordinating wireless device, a network node and at least one wireless device in a wireless communications network,

FIG. 8 is another signalling diagram illustrating embodiments of a coordinating wireless device, a network node and at least one wireless device in a wireless communications network,

FIG. 9 is a block diagram depicting embodiments of a coordinating wireless device,

FIG. 10 is a block diagram depicting embodiments of a network node,

FIG. 11 is a block diagram depicting embodiments of a wireless device.

### DETAILED DESCRIPTION

The figures are schematic and simplified for clarity, and they merely show details which are essential to the understanding of the embodiments presented herein, while other details have been left out. Throughout, the same reference numerals are used for identical or corresponding parts or steps.

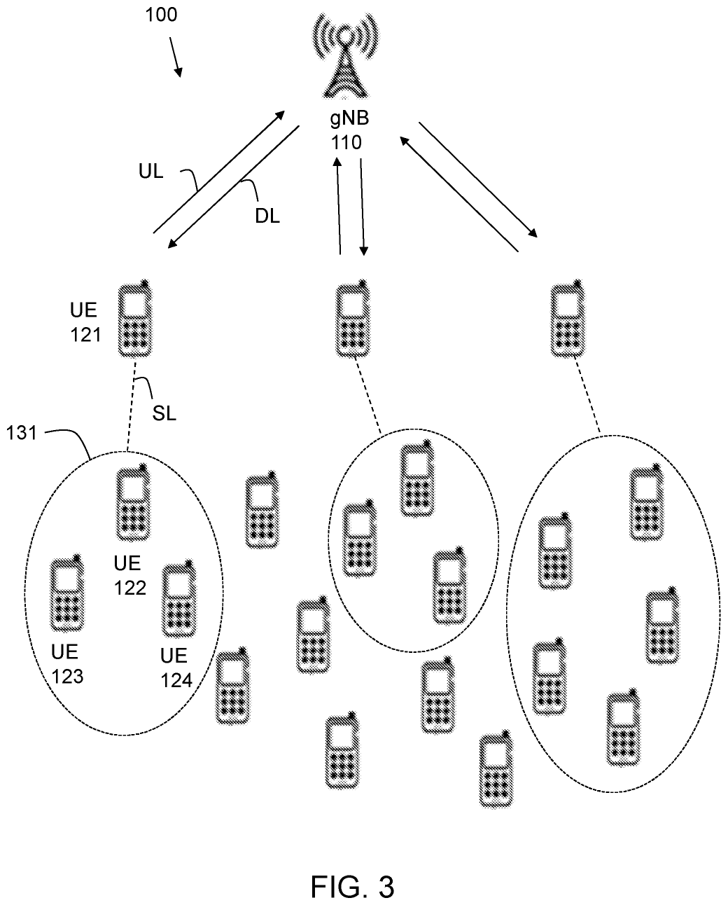

FIG. 3 depicts a wireless communications network 100 in which embodiments herein may operate. In some embodiments, the wireless communications network 100 may be a radio communications network, such as, 5G, NR or 6G network. Although, the wireless communications network 100 is exemplified herein as an 5G, NR or 6G network, the wireless communications network 100 may also employ technology of any one of LTE, LTE-Advanced, WCDMA, GSM/EDGE, WiMax, UMB, GSM, or any other similar network or system. The wireless communications network 100 may also employ technology of an Ultra Dense Network, UDN, which e.g. may transmit on millimetre-waves (mmW).

The wireless communications network 100 comprises a network node 110. The network node 110 may serve wireless devices in at least one cell or coverage area. The network node 110 may correspond to any type of network node or radio network node capable of communicating with a wireless device and/or with another network node, such as, a base station (BS), a radio base station, gNB, eNB, eNodeB, a Home NodeB, a Home eNodeB, a femto Base Station (BS), or a pico BS in the wireless communications network 100. Further examples of the network node 110 may be a repeater, multi-standard radio (MSR) radio node such as MSR BS, network controller, radio network controller (RNC), base station controller (BSC), relay, donor node controlling relay, base transceiver station (BTS), access point (AP), transmission points, transmission nodes, a Remote Radio Unit (RRU), a Remote Radio Head (RRH), nodes in distributed antenna system (DAS), or core network node.

In FIG. 3, at least one coordinating wireless device, such as, the coordinating wireless device 121, and at least one wireless device, such as, the wireless devices 122, 123, 124, are located within range of the network node 110. The coordinating wireless device 121 is configured to communicate within the wireless communications network 100 via the network node 110 over a radio link served by the network node 110. In other words, the coordinating wireless device 121 may be configured to transmit data over an air or radio interface to the network node 110 in uplink, UL, transmissions, and the network node 110 may transmit data over an air or radio interface to the coordinating wireless device 121 in downlink, DL, transmissions. The coordinating wireless device 121 and the wireless devices 122, 123, 124 may be any type of wireless devices or user equipments (UEs) communicating with a network node and/or with another wireless device in a cellular, mobile or radio communication network or system. Examples of such wireless devices are mobile phones, cellular phones, Personal Digital Assistants (PDAs), smart phones, tablets, sensors equipped with a UE, Laptop Mounted Equipment (LME) (e.g. USB), Laptop Embedded Equipments (LEEs), Machine Type Communication (MTC) devices, or Machine to Machine (M2M) device, Customer Premises Equipment (CPE), target device, device-to-device (D2D) wireless device, wireless device capable of machine to machine (M2M) communication.

In the scenario shown in FIG. 3, the physical distribution of the wireless devices with the cell of the network node 110 may form clusters or groups of wireless devices. In this case, for each group of wireless devices, there may be assigned a coordinating wireless device. Each wireless device in a group of wireless devices may be connected to and communicate with the coordinating wireless device over a Sidelink, SL, interface, e.g. PC5, or similar Device-to-Device, D2D, connection. In some cases, the coordinating wireless device may schedule wireless device in its group of wireless devices for transmissions on the UL. This may be performed by using, for example, configured grants for the UL that the wireless device in the group of wireless devices may use, but only after being scheduled by the coordinating wireless device.

One example of such a group of wireless devices is the group of wireless devices 131 comprising the wireless devices 122, 123, 124 served by the coordinating wireless device 121. Here, the group of wireless devices 131 may be established by the coordinating wireless device 121 and the network node 110. After creating and registering the group of wireless 131 with the network node 110, the coordinating wireless device 121 may also upon receiving requests from each of the wireless devices 122, 123, 124 to join the group of wireless devices 131 authenticate and associate each of the wireless devices 122, 123, 124 with the group of wireless devices 131. One example of how this may be performed is described in the patent application PCT/SE2019/050995, which is incorporated herein by reference. Hence, it should be noted that both the coordinating wireless device 121 and the network node 110 is aware of the wireless devices 122, 123, 124 in the group of wireless devices 131.

Sidelink, SL, transmissions over NR in Release 16 are basically enhancements of ProSe, PROximity-based Services, specified for LTE. Some of the main enhancements are:
Support for unicast and group-cast transmissions are added in NR SL. For unicast and group-cast, the physical SL feedback channel (PSFCH) is introduced for a receiving wireless device to reply the decoding status to a transmitting wireless device,
Grant-free transmissions, which are adopted in NR UL transmissions, are also provided in NR SL transmissions in order to reduce the latency,
A new design of PSCCH, with enhanced channel sensing and resource selection procedures, is introduced. This to alleviate resource collisions among different SL transmissions launched by different wireless devices, and
QoS management, e.g. congestion control, is supported in NR SL transmissions, in order to achieve a high connection density.

To enable the above enhancements, new physical channels and reference signals for SL are introduced in NR:
PSSCH (Physical Sidelink Shared Channel, SL version of PDSCH): The PSSCH is transmitted by a SL transmitting UE, which conveys SL transmission data, system information blocks (SIBs) for radio resource control (RRC) configuration, and a part of the SL control information (SCI).
PSFCH (Physical Sidelink, SL version of PUCCH): The PSFCH is used to transmit acknowledgements by a SL receiving UE for unicast and groupcast. The transmission conveys 1 bit information over 1 RB for the HARQ acknowledgement (ACK) and the negative ACK (NACK). Channel state information (CSI) is carried in the medium access control (MAC) control element (CE) over the PSSCH instead of the PSFCH.
PSCCH (Physical Sidelink Common Control Channel, SL version of PDCCH): Before transmitting data, a transmitting UE should first send (over PSCCH) a part of SCI (Sidelink Control information, SL version of DCI) to be decoded by any UE for channel sensing purposes, including the reserved time-frequency resources for transmissions, demodulation reference signal (DMRS) pattern and antenna port, etc.
Sidelink Primary/Secondary Synchronization Signal (SPSS/SSSS): Similar to downlink transmissions in NR, in SL transmissions, primary and secondary synchronization signals (called SPSS and SSSS, respectively) are supported. Through detecting the SPSS and SSSS, a UE is able to identify the SL synchronization identity (SSID) from the UE sending the SPSS/SSSS. Through detecting the SPSS/SSSS, a UE is therefore able to know the characteristics of the UE transmitting the SPSS/SSSS. The process of acquiring timing and frequency synchronization together with SSIDs of UEs is called initial cell search. Note that the UE sending the SPSS/SSSS may not be necessarily involved in SL transmissions, and a node (UE/eNB/gNB) sending the SPSS/SSSS is called a synchronization source. There are 2 SPSS sequences and 336 SSSS sequences forming a total of 672 SSIDs in a cell.
Physical Sidelink Broadcast Channel (PSBCH): The PSBCH is transmitted along with the SPSS/SSSS as a synchronization signal/PSBCH block (SSB). The SSB has the same numerology as PSCCH/PSSCH on that carrier, and an SSB should be transmitted within the bandwidth of the configured BWP. The PSBCH conveys information related to synchronization, such as the direct frame number (DFN), indication of the slot and symbol level time resources for SL transmissions, in-coverage indicator, etc. The SSB is transmitted periodically at every 160 ms.
DMRS, phase tracking reference signal (PT-RS), channel state information reference signal (CSIRS): These physical reference signals supported by NR downlink/uplink transmissions are also adopted by SL transmissions. The PT-RS is only applicable for FR2 transmission.

Another new feature is the two-stage SL control information, SCI. This a version of the DCI for SL. Unlike the DCI, only part (first stage) of the SCI is sent on the PSCCH. This part is used for channel sensing purposes, including the reserved time-frequency resources for transmissions, Demodulation Reference Signal, DMRS, pattern and antenna port, etc., and can be read by all wireless devices while the remaining (second stage) scheduling and control information, such as a 8-bits source identity, ID, and a 16-bits destination ID, NDI, RV and HARQ process ID, is sent on the PSSCH to be decoded by the receiving wireless device.

Similar as for PROSE in LTE, NR SL transmissions have the following two modes of resource allocation, i.e. Mode 1: SL resources are scheduled by a gNB, and Mode 2: The wireless device autonomously selects SL resources from a pre-configured SL resource pool(s) based on the channel sensing mechanism. For the in-coverage wireless device, a gNB can be configured to adopt Mode 1 or Mode 2. For the out-of-coverage wireless device, only Mode 2 can be adopted. As in LTE, scheduling over the SL in NR is done in different ways for Mode 1 and Mode 2.

Mode 1 supports the following two kinds of grants, dynamic grants and configured grants. For dynamic grants, when the traffic to be sent over SL arrives at a transmitting wireless device, this transmitting wireless device may launch a four-message exchange procedure, i.e. a Status Report (SR) on UL, a grant, a Buffer Status Report (BSR) on UL, and a grant for data on SL sent to the wireless device, to request SL resources from a gNB. During the resource request procedure, a gNB may allocate a SL radio network temporary identifier, SL-RNTI, to the transmitting wireless device. If this SL resource request is granted by a gNB, then the gNB indicates the resource allocation for the PSCCH and the PSSCH in the Downlink Control Information, DCI, conveyed by PDCCH with CRC scrambled with the SL-RNTI. When a transmitting wireless device receives such a DCI, the transmitting wireless device may obtain the grant only if the scrambled CRC of the DCI can be successfully solved by the assigned SL-RNTI. The transmitting wireless device then indicates the time-frequency resources and the transmission scheme of the allocated PSSCH in the PSCCH and launches the PSCCH and the PSSCH on the allocated resources for SL transmissions. When a grant is obtained from a gNB, a transmitting wireless device may only transmit a single TB. As a result, this kind of grant is suitable for traffic with a loose latency requirement. For configured grants, when having traffic with a strict latency requirement, performing the four-message exchange procedure to request SL resources may introduce unacceptably high latency. In this case, prior to the traffic arrival, a transmitting wireless device may perform the four-message exchange procedure and request a set of reoccurring resources. If a grant can be obtained from a gNB, then the requested resources are reserved in a periodic manner. Upon traffic arriving at a transmitting wireless device, this transmitting wireless device may launch the PSCCH and the PSSCH on the upcoming resource occasion. This kind of grant is also known as grant-free transmissions. It should be noted that, in both dynamic grant and configured grant, a SL receiving wireless device cannot receive the DCI, since it is addressed to the transmitting wireless device. Therefore, a receiving wireless device may perform blind decoding to identify the presence of PSCCH and find the resources for the PSSCH through the SCI. When a transmitting wireless device launches the PSCCH, CRC is also inserted in the SCI without any scrambling.

In Mode 2 resource allocation, when traffic arrives at a transmitting wireless device, this transmitting wireless device may autonomously select resources for PSCCH and PSSCH. To further minimize the latency of the feedback HARQ ACK/NACK transmissions and subsequently retransmissions, a transmitting wireless device may also reserve resources for PSCCH/PSSCH retransmissions. To further enhance the probability of successful Transmission Block, TB, decoding at one shot and thus suppress the probability to perform retransmissions, a transmitting wireless device may repeat the TB transmission along with the initial TB transmission. This mechanism is also known as blind retransmission. As a result, when traffic arrives at a transmitting wireless device, then this transmitting wireless device may select resources for the following transmissions:
The PSSCH associated with the PSCCH for initial transmission and blind retransmissions, and
The PSSCH associated with the PSCCH for retransmissions.

Since each transmitting wireless device in SL transmissions should autonomously select resources for above transmissions, how to prevent different transmitting wireless devices from selecting the same resources turns out to be a critical issue in Mode 2. A particular resource selection procedure is therefore imposed to Mode 2 based on channel sensing. The channel sensing algorithm involves measuring RSRP on different sub-channels and requires knowledge of the different wireless devices power levels of DMRS on the PSSCH or the DMRS on the PSCCH depending on the configuration. This information is known only after receiving SCI launched by (all) other wireless devices. The sensing and selection algorithm is rather complex.

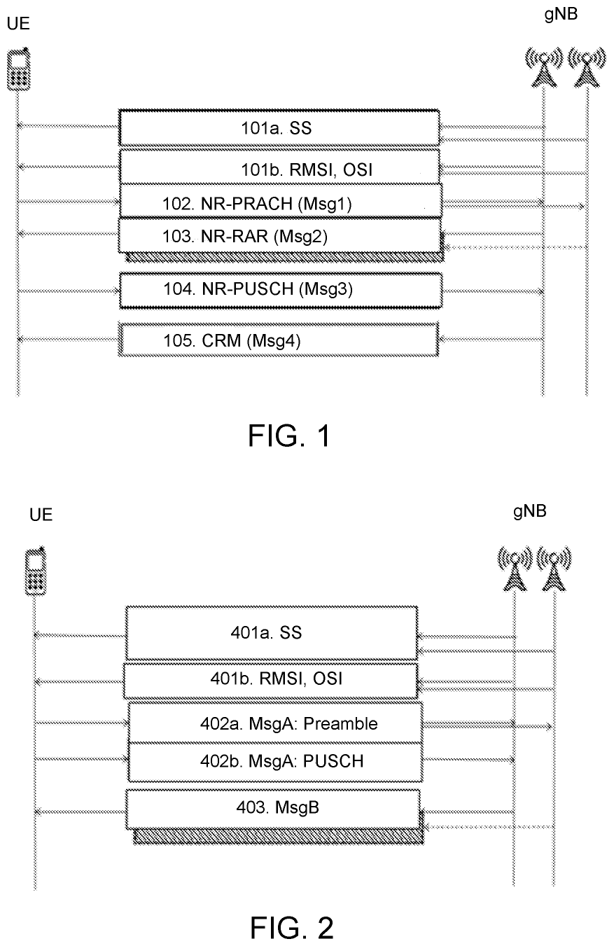

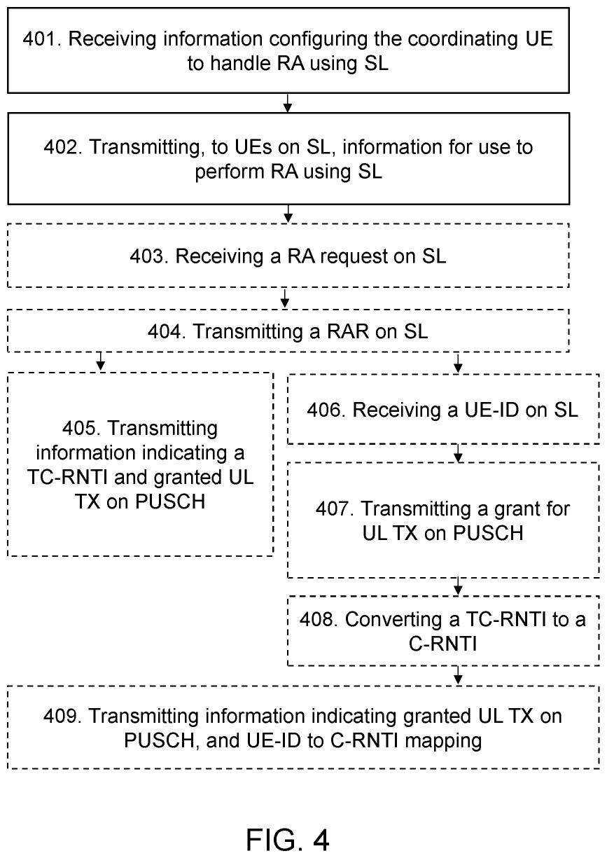

As part of the developing of the embodiments described herein, it has been realized that the groups of wireless devices being coordinated by a coordinating wireless device over SL in a wireless communications network, such as, e.g. shown in FIG. 3, may also be used for improving RA in wireless communications networks. In other words, it has been realized that RA may be performed over SL to a coordinating wireless device which, after contention resolution, may schedule the first data of a wireless device in its group of wireless devices for transmission on the UL. This means, for example, that SL may be used for the Msg1-4 transmissions of the 4-step RA procedure shown in FIG. 1, thus reducing the problems with over-load on the normal PRACH resources within a cell of a network node. This is enabled by the embodiments described herein with reference to FIGS. 4-11 below.

For example, by having the coordinating wireless device configured by the network node with the necessary system information needed for any wireless device in its group of wireless devices to initiate a RA attempts towards the network node via the coordinating wireless device. Here, it may be assumed that the network node is also aware of the wireless devices in each group of wireless devices and have “accepted” them when the group of wireless devices was created and registered. Therefore, the network node may also configure the coordinating wireless device with the temporary network identities, TC-RNTIs, which the coordinating wireless device may assign to the wireless devices in the group of wireless devices when attempting RA.

Ideally, the group of wireless devices should be located close to each other and the group of wireless devices should also only contain a limited number of devicesError! Reference source not found. This means that the Timing Advance, TA, of the coordinating wireless device may be used by the wireless devices in the group of wireless devices. The PRACH resources assigned for the group of wireless devices may then be re-used by other groups of wireless devices which are located far enough away to be isolated from other groups with the same PRACH resources. The PRACH resources may here refer to both time and frequency resources when to transmit preambles, and preambles.

An advantage is here that the wireless devices may make a faster RA attempt since the collision probability of the preamble transmissions is reduced due to the limited number of users within each group of wireless devices. Since the coordinating wireless device will be close to the group of wireless devices and thus facilitate good propagation conditions, this will result in a reduced risk of the wireless devices having to repeat preamble transmissions and thus lead to fewer retransmissions. This will consequently result in that less power is needed in the wireless devices. Another advantage on a network level is also that, since the PRACH resources may be reused in different groups of wireless devices, the overall PRACH resources in UL needed on a cell level is reduced. Furthermore, the PRACH resources may here also easily be adapted to the number of wireless devices in the group of wireless devices and the number of isolated groups of wireless devices. These advantages may be of particular interest and benefit for MTC/IoT scenarios with many wireless devices and bursty traffic, but may also be applicable and useful for any type of scenario.

Examples of embodiments of a method performed by a coordinating wireless device 121 for enabling a group of wireless devices 131 to perform uplink, UL, transmissions towards a network node 110 in a wireless communications network 100, will now be described with reference to the flowchart depicted in FIG. 4. FIG. 4 is an illustrated example of actions or operations which may be taken by the coordinating wireless device 121 in the wireless communication network 100. The method may comprise the following actions.

### Action 401

The coordinating wireless device 121 receives from the network node 110, information configuring the coordinating wireless device 121 to handle Random Access, RA, using Sidelink, SL, resources towards wireless devices 122, 123, 124 in the group of wireless devices 131. This means that the coordinating wireless device 121 may be configured by the network node 110 to send system information, such as, for example, MIB and SIB1 (or parts thereof), over the SL to the wireless devices 122, 123, 124 in the group of wireless devices 131. The coordinating wireless device 121 may here also be configured with UL configured grants resources for the wireless devices 122, 123, 124 in the group of wireless devices 131 to be used for small data transmissions from the wireless devices 122, 123, 124 to the network node 110 on the UL, e.g. their first data transmissions on the UL. This may also be referred to as group configured grants.

In some embodiments, the received information comprises information indicating a set of temporary network identifiers, TC-RNTIs, to be assigned to wireless devices in the group of wireless devices 131 by the coordinating wireless device 121 during RA. This means that the coordinating wireless device 121 may further be configured with temporary network identifiers, TC-RNTIs, for wireless devices 122, 123, 123 in the group of wireless devices 131. Optionally, the coordinating wireless device 121 may here also request further temporary network identifiers, TC-RNTIs, for the group of wireless devices 131 from the network node 110 in case more wireless devices is joining the group of wireless devices 131.

### Action 402

After receiving the configuration information in Action 401, the coordinating wireless device 121 transmits, to the wireless devices 122, 123, 124 in the group of wireless devices 131 on SL resources, information for use by the wireless devices 122, 123, 124 in the group of wireless devices 131 to perform RA using SL resources towards the coordinating wireless device 121. This means that the coordinating wireless device 121 may transmit its RACH system information to the wireless device 122 on SL, i.e. a PRACH configuration of the coordinating wireless device 121 on the SL for the wireless devices 122, 123, 124 in the group of wireless devices 131, and system information, i.e. MIB and SIB1 (or parts thereof). This may be transmitted by the coordinating wireless device 121 on a Physical Broadcast Channel, PBCH, e.g. via an Information Element, IE, similar to a RACH-ConfigCommon IE. In some embodiments, the coordinating wireless device 121 may transmit system information received from the network node 110 to the wireless devices 122, 123, 124 in the group of wireless devices 131 periodically on SL resources. This means that the coordinating wireless device 121 may periodically transmit the system information, i.e. MIB and SIB1 (or parts thereof), received from the network node 110 to the wireless device 122, 123, 124 in the group of wireless devices 131.

### Action 403

After the transmission in 402, the coordinating wireless device 121 may receive a RA request from a wireless device 122 in the group of wireless devices 131 on SL resources. This means that the coordinating wireless device 121 may receive a message corresponding to the Msg1 of an RA procedure from the wireless device 122 over SL. In other words, when a RA attempt is triggered in the wireless device 122 in the group of wireless devices 131, the wireless device 122 will send a preamble to the coordinating wireless device 121 on the SL. Besides the preamble, the RA request may also comprise a preferred SSB of the network 110, and may be transmitted over the SL PRACH.

In some embodiments, the RA request from the wireless device 122 may comprise a preamble specifically assigned to the wireless device 122 in the coordinating device 121. In current LTE and NR standards it is not possible to have Contention-Free RA, CFRA, for wireless devices in the RRC states IDLE and INACTIVE. This is due to the shortage of preamble resources and devoting a number of them to wireless devices currently in IDLE or INACTIVE would not be viable. However, in some embodiments herein, this would not be difficult since the PRACH resources are only shared between the wireless devices in the group of wireless devices, e.g. by the wireless devices 122, 123, 124 in the group of wireless devices 131. This means that CFRA may be supported from a resource usage perspective. Thus, in this case of using CFRA, the wireless device 122 may be assigned a specific preamble. Optionally, the wireless device 122 may be assigned a set of preambles if, e.g. SSB indication is also done via preambles. This means that when the coordinating wireless device 121 here receives the RA request, i.e. the specifically assigned preamble(s), from the wireless device 122, the coordinating wireless device 121 already knows the UE ID to TC-RNTI mapping, since no contention resolution is needed. Thus, as the coordinating wireless device 121 below in Action 404 transmits a RAR with TC-RNTI, which may be directly is promoted to C-RNTI, and a grant for the normal UL to the wireless device 122, the coordinating wireless device 121 may also transmit information in Action 409 to the network node 110, i.e. that the wireless device 122 in the group of wireless devices 131 has made a RA attempt and information indicating the resulting UE ID to C-RNTI mapping. This information may also comprise the grant occasion where the wireless device 122 will transmit its first UL message to the network node 110. One additional advantage with these embodiments is that there is no collision probability due to CFRA. Compared to legacy, this may be one way of doing CFRA also for wireless device in IDLE and INACTIVE.

### Action 404

After receiving the RA request in Action 403, the coordinating wireless device 121 may transmit a Random Access Response, RAR, to the wireless device 122 in the group of wireless devices 131 on SL resources. This means that the coordinating wireless device 121 may transmit a message corresponding to Msg2 of an RA procedure towards the wireless device 122 over SL. This may be performed over SL PSSCH.

In some embodiments, the RAR may comprise information indicating a grant for transmitting the identifier, UE-ID, of the wireless device 122 to the coordinating wireless device 121 on SL resources, a temporary network identifier TC-RNTI assigned to the wireless device 122, and a Timing Advance, TA, of the coordinating wireless device 121.

This means that the coordinating wireless device 121 may choose a TC-RNTI among those TC-RNTIs that has been assigned to the coordinating wireless device 121 by the network node 110. The coordinating wireless device 121 also transmits the TA of the coordinating wireless device 121, and a grant for msg3 on the SL to the wireless device 122. It is here assumed that the group of wireless devices 131 is small, i.e. comprise only a few wireless devices, and that all wireless devices 122, 123, 124 in the group of wireless devices 131 may use the same TA as the coordinating wireless device 121. In this case, the last two steps of the RA procedure, i.e. Msg3-Msg4, will take place between the coordinating wireless device 121 and the wireless device 122 as described in Actions 406-407.

In some embodiments, the RAR may comprise information indicating a grant for the UL data transmission towards the network node 110 on the PUSCH resources and the assigned temporary network identifier, TC-RNTI. In this case, the coordinating wireless device 121 has received the TC-RNTIs from the network node 110, but the mapping between TC-RNTI and UE ID is performed by the network node 110. Hence, the coordinating wireless device 121 may here schedule the Msg3 to be transmitted by the wireless device 122 on the UL towards the network node 110. Thus, in this case, the last two steps of the RA procedure, i.e. Msg3-Msg4, will take place between the wireless device 122 and the network node 110, while the coordinating wireless device 121 notifies the network node 110 as described in Action 405 below.

### Action 405

Optionally, after transmitting the RAR in Action 404, the coordinating wireless device 121 may transmit, to the network node 110, information indicating that the wireless device 122 has been assigned a temporary network identifier, TC-RNTI, for use by the wireless device 122 in an UL data transmission towards the network node 110 on Physical Uplink Shared Channel, PUSCH, resources granted by the coordinating wireless device 121. In other words, the coordinating wireless device 121 may transmit information indicating that the TC-RNTI of the wireless device 122 will be sent at UL grant indication. This option has the same advantage as the other option described in Action 407-409, i.e. saving PRACH resources in UL, but in this case the signalling is switched to UL/DL in a faster way and the network node 110 takes care of the contention resolution. Since the control is switched to the network node 110 in a faster way, the network node 110 may provide a larger grant to the wireless device 122 if suitable.

### Action 406

According to another option, after transmitting the RAR in Action 404, the coordinating wireless device 121 may receive, from the wireless device 122 on SL resources, information indicating the identifier, UE-ID, of the wireless device 122. This means that the coordinating wireless device 121 may receive a message corresponding to Msg3 of an RA procedure from the wireless device 122 over SL. This may be performed over SL PSSCH, and may, beside the UE-ID, also comprise a Buffer Status Report, BSR. Optionally, the information may also comprise a SSB number selected by the wireless device 122, e.g. as a data field.

### Action 407

After receiving the identifier of the wireless device 122 in Action 406, the coordinating wireless device 121 may transmit, to the wireless device 122 on SL resources, information indicating a grant for the UL data transmission towards the network node 110 on the PUSCH resources using the received identifier, UE-ID, of the wireless device 122. This means that the coordinating wireless device 121 may transmit a message corresponding to Msg4 of an RA procedure towards the wireless device 122 over SL. In other words, the coordinating wireless device 121 may respond with the UE ID of the wireless device 122 in order to settle the contention resolution. The information may also comprise a PUSCH grant occasion on the UL PUSCH resources that is controlled by the coordinating wireless device 121.

### Action 408

After transmitting the grant to the wireless device 122 in Action 407, the coordinating wireless device 121 may convert the temporary network identifier, TC-RNTI, assigned to the wireless device 122 to a network identifier, C-RNTI, of the wireless device 122 in the wireless communication network 100. In other words, the coordinating wireless device 121 promotes the TC-RNTI to a C-RNTI.

### Action 409

After the conversion in Action 408, the coordinating wireless device 121 may transmit, to the network node 110, information indicating that the wireless device 122 has been provided with a grant for an UL data transmission towards the network node 100 on PUSCH resources, and information indicating a mapping of an identifier, UE-ID, of the wireless device 122 to a network identifier, C-RNTI, of the wireless device 122 in the wireless communication network 100. This means that the coordinating wireless device 121 may inform the network node 110 that the wireless device 122 in the group of wireless devices 131 has made a RA attempt via the coordinating wireless device 121, i.e. a group RACH, and also inform the network node 110 about the resulting UE ID to C-RNTI mapping. The latter following the contention resolution. The information may also comprise the grant occasion where the wireless device 122 will transmit its first UL message and the preferred SSB. In case the information received in Action 406 comprised a BSR, this may also be included in the information to the network node 110 by the coordinating wireless device 121.

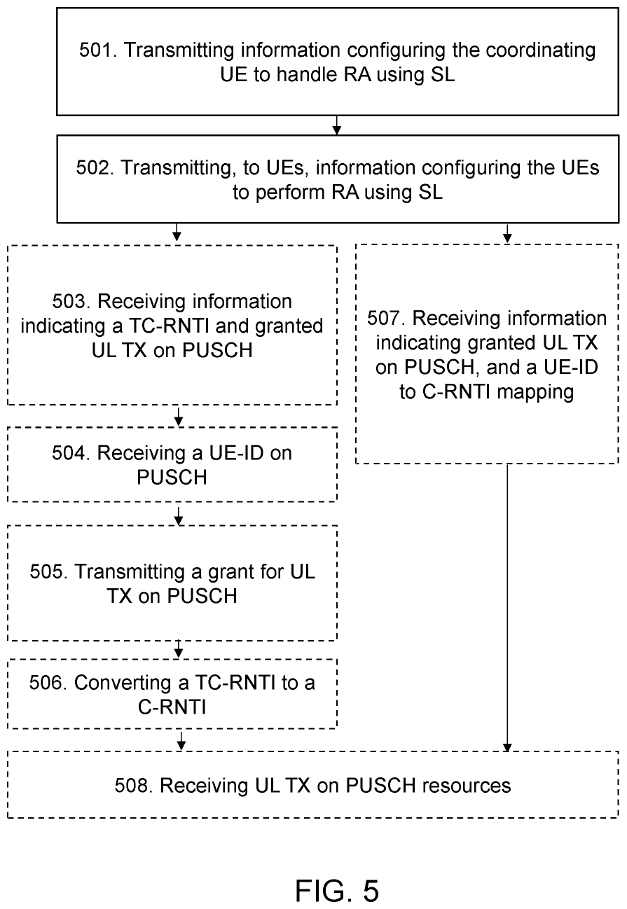

Examples of embodiments of a method performed by a network node 110 for enabling a group of wireless devices 131 to perform uplink, UL, transmissions towards the network node 110 in a wireless communications network 100, will now be described with reference to the flowchart depicted in FIG. 5. FIG. 5 is an illustrated example of actions or operations which may be taken by the network node 110 in the wireless communication network 100. The method may comprise the following actions.

### Action 501

The network node 110 transmit, to a coordinating wireless device 121, information configuring the coordinating wireless device 121 to handle Random Access, RA, using Sidelink, SL, resources towards wireless devices in a group of wireless devices 131 associated with the coordinating wireless device 121. This means that the network node 110 may configure the coordinating wireless device 121 to transmit system information, such as, for example, MIB and SIB1 (or parts thereof), over the SL to the wireless devices 122, 123, 124 in the group of wireless devices 131. This may be configured by the network node 110 to be performed periodically by the coordinating wireless device 121. The network node 110 may here also configure the coordinating wireless device 121 with UL configured grants resources for the wireless devices 122, 123, 124 in the group of wireless devices 131 to be used for small data transmissions from the wireless devices 122, 123, 124 to the network node 110 on the UL, e.g. their first data transmissions on the UL. This may also be referred to as group configured grants.

### Action 502

The network node 110 also transmits to the wireless devices 122, 123, 124 in the group of wireless devices 131, information configuring the wireless devices 122, 123, 124 in the group of wireless devices 131 to perform RA using SL resources towards the coordinating wireless device 121. This means that the network node 110 may configure the wireless devices 122, 123, 124 in the group of wireless devices 131 to listen to the RACH system information, i.e. the MIB and SIB1 (or parts thereof), that is transmitted by the coordinating wireless device 121 on SL resources. Here, the wireless devices 122, 123, 124 in the group of wireless devices 131 initially reads the MIB and the SIB1 from the network node 110 that is periodically transmitted and which may comprise this configuration information. The configuration information from the network node 11 may thus inform the wireless devices 122, 123, 124 in the group of wireless devices 131 exactly where the RACH system information will be transmitted on the SL by the coordinating wireless device 121 and by which coordinating wireless device, i.e. the coordinating wireless device 121.

### Action 503

Optionally, after the transmissions in Actions 501-502, the network node 110 may receive, from the coordinating wireless device 121, information indicating that a wireless device 122 in the group of wireless devices 131 has been assigned a temporary network identifier, TC-RNTI, for use by the wireless device 122 in an UL data transmission towards the network node 100 on Physical Uplink Shared Channel, PUSCH, resources granted by the coordinating wireless device 121. In this case, the coordinating wireless device 121 has received the TC-RNTIs from the network node 110, but the mapping between TC-RNTI and UE ID is to be performed by the network node 110.

### Action 504

After receiving the information in Action 503, the network node 110 may receive, from the wireless device 122, information indicating the identifier, UE-ID, of the wireless device 122. This means that the network node 110 may receive a message corresponding to Msg3 of an RA procedure from the wireless device 122 in the wireless communications network 100. Besides the UE-ID of the wireless device 122, the information may also indicate a preferred SSB selected by the wireless device 122. The information may be received on UL PUSCH.

### Action 505

After receiving the information from the wireless device 122 in Action 504, the network node 110 may transmit, to the wireless device 122, information indicating a grant for the UL data transmission towards the network node 110 on the PUSCH resources using the received identifier, UE-ID, of the wireless device 122. This means that the network node 110 may transmit a message corresponding to Msg4 of an RA procedure to the wireless device 122 in the wireless communications network 100. Here, it should be noted that having the last two steps of the RA procedure, i.e. Msg3-Msg4, performed between the wireless device 122 and the network node 110 will advantageously save PRACH resources in UL, but also allow the network node 110 to provide a larger grant to the wireless device 122 in the Msg4 since the signalling is switched to UL/DL faster and the network node 110 is taking care of the contention resolution.

### Action 506

After the transmission in Action 505, the network node 110 may convert the temporary network identifier, TC-RNTI, assigned to the wireless device 122 to a network identifier, C-RNTI, of the wireless device 122 in the wireless communication network 100. In other words, the network node 110 promotes the TC-RNTI to a C-RNTI.

### Action 507

According to another option, after the transmissions in Actions 501-502, the network node 110 may receive, from the coordinating wireless device 121, information indicating that a wireless device 122 in the group of wireless devices 131 has been provided with a grant for an UL data transmission towards the network node 100 on PUSCH resources, and information indicating a mapping of an identifier, UE-ID, of the wireless device 122 to a network identifier, C-RNTI, of the wireless device 122 in the wireless communication network 100. This means that the network node 110 is informed by the coordinating wireless device 121 that the wireless device 122 in the group of wireless devices 131 has made a RA attempt via the coordinating wireless device 121. The network node 110 is also informed about the UE ID to C-RNTI mapping following the contention resolution of the coordinating wireless device 121. The information may also comprise the grant occasion where the wireless device 122 will transmit its first UL message and the preferred SSB. Additionally, the information may also comprise a Buffer Status Report, BSR.

### Action 508

After the transmission in Action 505 or receiving the information in Action 507, the network node 110 may receive, from the wireless device 122, an UL data transmission on PUSCH resources. The UL data transmission may, for example, be a small data transmission from the wireless devices 122, 123, 124 to the network node 110, e.g. a first data transmission of the wireless device 122 on the UL. However, if a larger grant has been provided in Action 505, the amount of data in the UL data transmission may be allowed to be larger.

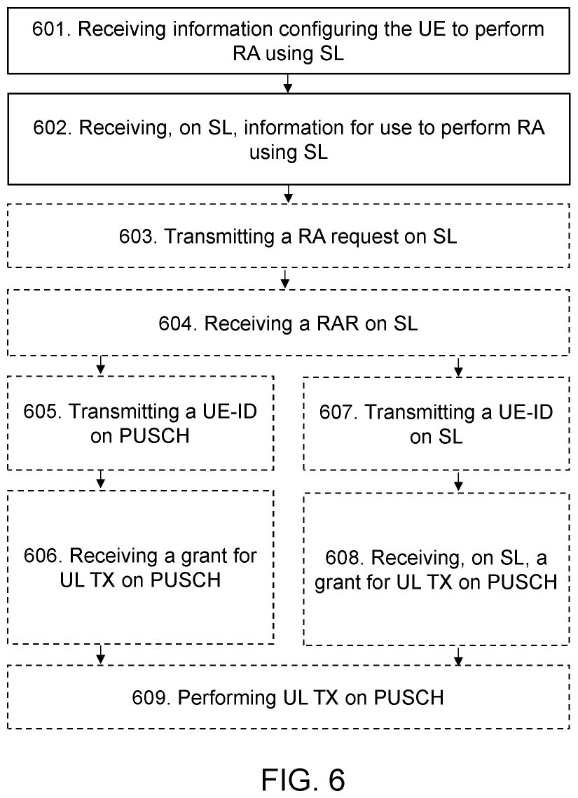

Examples of embodiments of a method performed by a wireless device 122 for enabling uplink, UL, transmissions towards a network node 110 in a wireless communications network 100, will now be described with reference to the flowchart depicted in FIG. 6. FIG. 6 is an illustrated example of actions or operations which may be taken by the wireless device 122 in the group of wireless devices 131 in the wireless communication network 100. The method may comprise the following actions.

### Action 601

The wireless device 122 receives, from the network node 110, information configuring the wireless device 122 to perform Random Access, RA, using Sidelink, SL, resources towards a coordinating wireless device 121 associated with the wireless device 122. This means that the wireless device 122 may be configured by the network node 110 to listen to the RACH system information, e.g. the MIB and SIB1 (or parts thereof), that is transmitted by the coordinating wireless device 121 on SL resources. Here, the wireless devices 122, 123, 124 in the group of wireless devices 131 initially reads the MIB and the SIB1 from the network node 110 that is periodically transmitted and which may comprise this configuration information. The configuration information from the network node 11 may thus informs the wireless devices 122, 123, 124 in the group of wireless devices 131 exactly where the RACH system information will be transmitted on the SL by the coordinating wireless device 121 and by which coordinating wireless device, i.e. the coordinating wireless device 121.

### Action 602

After receiving the information in Action 601, the wireless device 122 receives, from the coordinating wireless device 121 on SL resources, information for use by the wireless device 122 to perform RA using SL resources towards the coordinating wireless device 121. This means that the wireless device 122 may receive the RACH system information of the coordinating wireless device 121 on SL, i.e. a PRACH configuration of the coordinating wireless device 121 on the SL for the wireless devices 122, 123, 124 in the group of wireless devices 131, and system information, i.e. MIB and SIB1 (or parts thereof). This may be received by the wireless device 1212 on a Physical Broadcast Channel, PBCH, e.g. via an Information Element, IE, similar to a RACH-ConfigCommon IE. In some embodiments, the wireless device 121 may periodically receive system information, i.e. MIB and SIB1 (or parts thereof), from the coordinating wireless device 121 on the SL.

### Action 603

After receiving the information in Actions 601-602, the wireless device 122 may transmit a RA request to the coordinating wireless device 121 on SL resources. This means that the wireless device 122 may transmit a message corresponding to Msg1 of an RA procedure towards the coordinating wireless device 121 over SL. Typically, the wireless device 122 may select a suitable SSB, or beam, by selecting different preambles and RACH occasions. This may be performed according to a configuration by network node 110 as previously described for the RA procedure in the background above. In this case, the network node 110 may here assume that the last used SSB of the coordinating wireless device 121 may be used by the wireless device 122. However, optionally, the wireless device 122 may transmit a preferred SSB to the coordinating wireless device 121, where the choice of RA occasion then indicates the SSB number.

### Action 604

After the transmission in Action 603, the wireless device 122 may receive a Random Access Response, RAR, from the coordinating wireless device 121 on SL resources. This means that the wireless device 122 may receive a message corresponding to Msg2 of an RA procedure from the coordinating wireless device 121 over SL.

### Action 605

Optionally, in case the RAR received in Action 604 comprise information indicating a grant for the UL data transmission towards the network node 110 on the PUSCH resources and an assigned temporary network identifier TC-RNTI, the wireless device 122 may transmit, to the network node 110, information indicating the identifier, UE-ID, of the wireless device 122. This means that the wireless device 122 may transmit a message corresponding to Msg3 of an RA procedure towards the network node 110 in the wireless communications network 100. Besides the UE-ID of the wireless device 122, the information may also indicate a preferred SSB selected by the wireless device 122. The information may be transmitted on UL PUSCH.

### Action 606

After the transmission in Action 605, the wireless device 122 may receive, from the network node 110, information indicating a grant for the UL data transmission towards the network node 110 on the PUSCH resources using the received identifier, UE-ID, of the wireless device 122. This means that the wireless device 122 may receive a message corresponding to Msg4 of an RA procedure from the network node 110 in the wireless communications network 100. In other words, the network node 110 may respond with the UE ID of the wireless device 122 in order to settle the contention resolution. The information may be transmitted on DL PUSCH.

### Action 607

According to another option, in case the RAR received in Action 604 comprise a grant for transmitting the identifier, UE-ID, of the wireless device 122 to the coordinating wireless device 121 on SL resources, a temporary network identifier, TC-RNTI, assigned to the wireless device 122, and a Timing Advance, TA, of the coordinating wireless device 121, the wireless device 122 may transmit, to the coordinating wireless device 121 on SL resources, information indicating the identifier, UE-ID, of the wireless device 122. This means that the wireless device 122 may transmit a message corresponding to Msg3 of an RA procedure towards the coordinating wireless device 121 over SL. This may be performed over SL PSSCH, and may, beside the UE-ID, also comprise a Buffer Status Report, BSR. Optionally, the information may also comprise a SSB number selected by the wireless device 122, e.g. as a data field.

### Action 608

After the transmission in Action 607, the wireless device 122 may receive, from the coordinating wireless device 121 on SL resources, information indicating a grant for the UL data transmission towards the network node 110 on the PUSCH resources using the received identifier, UE-ID, of the wireless device 122. This means that the wireless device 122 may receive a message corresponding to Msg4 of an RA procedure from the coordinating wireless device 121 over SL. In other words, the coordinating wireless device 121 may respond with the UE ID of the wireless device 122 in order to settle the contention resolution. The information may also comprise a PUSCH grant occasion on the UL PUSCH resources that is controlled by the coordinating wireless device 121.

### Action 608

After receiving the information in Action 606 or Action 608, the wireless device 122 may perform, to the network node 110, an UL transmission on PUSCH resources. The UL data transmission may, for example, be a small data transmission from the wireless devices 122, 123, 124 to the network node 110, e.g. a first data transmission of the wireless device 122 on the UL. However, if a larger grant has been provided in Action 606, the amount of data in the UL data transmission may be allowed to be larger.

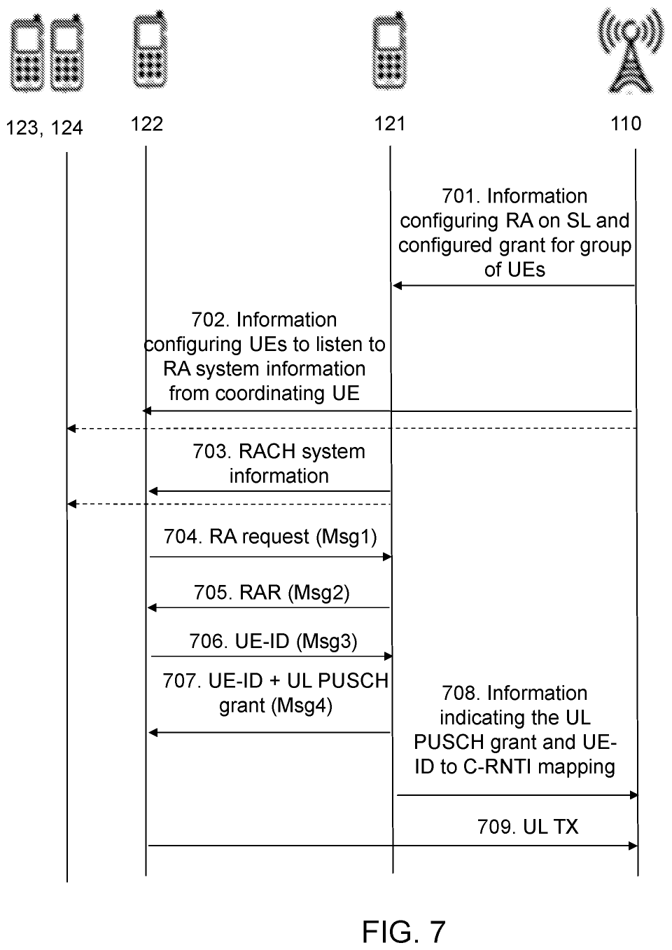

FIG. 7 shows a signalling diagram illustrating embodiments of a wireless device 121, a coordinating wireless device 121 and a network node 110 in a wireless communications network 100. In this scenario, the RA procedure for the wireless device 122 in the group of wireless devices 131 is performed between the coordinating wireless device 121 and the wireless device 122. In other words, Msg1 to Msg4 of the RA procedure occurs on the SL between the coordinating wireless device 121 and the wireless device 122.

Action 701. The network node 110 transmits, to the coordinating wireless device 121, information configuring the coordinating wireless device 121 with SL RA capability and group configured grants for the group of wireless devices 131.

Action 702. The network node 110 also transmits, to the group of wireless devices 131, information configuring group of wireless devices 131 to listen to RACH system information transmitted from the coordinating wireless device 121.

Action 703. The coordinating wireless device 121 may then broadcast system information in MIB and SIB1 on the Physical Sidelink Broadcasting Channel, PSBCH, comprising the RACH system information of the coordinating wireless device 121 to be used by the group of wireless devices 131 for performing RA towards the coordinating wireless device 121 over SL.

Action 704. When a RA is triggered in the wireless device 122 in the group of wireless devices 131, the wireless device 122 transmits a preamble, i.e. Msg1, to the coordinating wireless device 131. In case the wireless device 122 has a preferred SSB, this may also be indicated herein.

Action 705. In response to receiving the preamble, the coordinating wireless device 131 transmits a RAR comprising a TC-RNTI, i.e. Msg2, to the wireless device 122. These may be transmitted on the Physical Sidelink Shared Channel, PSSCH.

Action 706. In response to receiving the RAR and TC-RNTI, the wireless device 122 transmits its UE-ID, i.e. Msg3, to the coordinating wireless device 131. This may also be transmitted on the Physical Sidelink Shared Channel, PSSCH.

Action 707. In response to receiving the UE-ID, the coordinating wireless device 131 transmits a message, i.e. Msg4, comprising the UE-ID settling the contention resolution. The message also comprises a Physical Uplink Shared Channel, PUSCH, grant occasion on the UL PUSCH resources controlled by the coordinating wireless device 131. This may also be transmitted on the Physical Sidelink Shared Channel, PSSCH.

Action 708. The coordinating wireless device 121 may then transmit, to the network node 110, information indicating the UL PUSCH grant and UE-ID to C-RNTI mapping for the wireless device 122. In case the wireless device 122 has indicated a preferred SSB to the coordinating wireless device 121, this may also be indicated herein.

Action 709. The wireless device 122 may then perform an UL data transmission on the granted PUSCH resources to the network node 110.

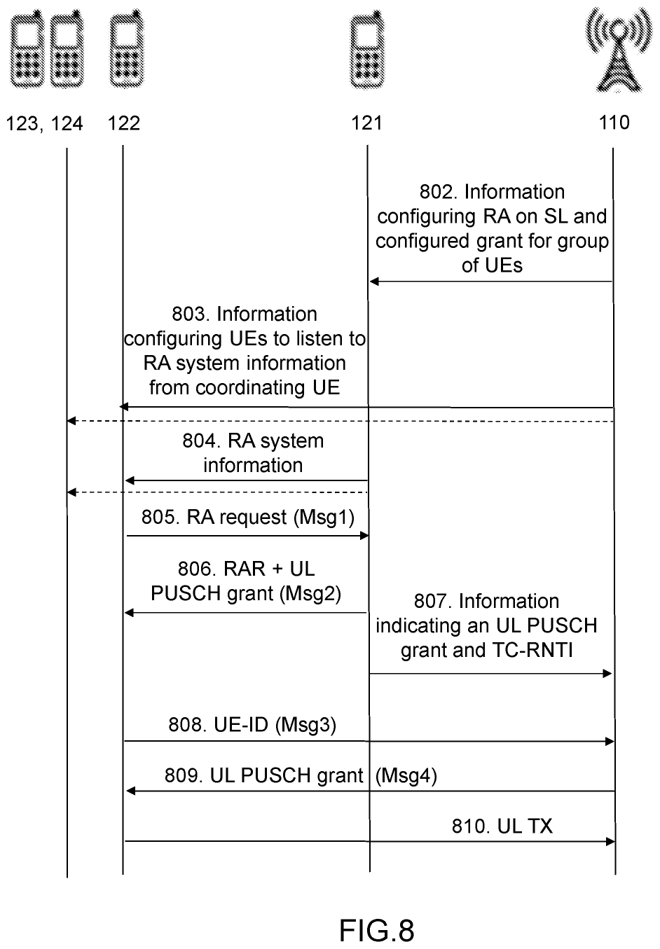

FIG. 8 shows another signalling diagram illustrating embodiments of a wireless device 121, a coordinating wireless device 121 and a network node 110 in a wireless communications network 100. In this scenario, a part of the RA procedure for the wireless device 122 is performed between the coordinating wireless device 121 and the wireless device 122, while another part of the RA procedure for the wireless device 122 is performed between the network node 110 and the wireless device 122. In other words, Msg1 to Msg2 of the RA procedure occurs on the SL between the coordinating wireless device 121 and the wireless device 122, while Msg3 to Msg4 of the RA procedure occurs on the UL PUSCH between the network node 110 and the wireless device 122.

Actions 801-805 are identical to the Actions 701-705 described above with reference to the signalling diagram in FIG. 7.

Action 805. In response to receiving the preamble, the coordinating wireless device 131 transmits a RAR comprising a TC-RNTI, i.e. Msg2, to the wireless device 122. Here, the coordinating wireless device 131 also transmits a Physical Uplink Shared Channel, PUSCH, grant occasion on the UL PUSCH resources controlled by the coordinating wireless device 131. These may be transmitted on the Physical Sidelink Shared Channel, PSSCH.

Action 806. The coordinating wireless device 131 may transmits information indicating the UL PUSCH grant and TC-RNTI of the wireless device 122.

Action 807. In response to the RAR and the UL PUSCH grant, the wireless device 122 transmits its UE-ID, i.e. Msg3, to the network node 110 on the granted UL PUSCH resources. In case the wireless device 122 has a preferred SSB, this may also be indicated herein.

Action 808. In response to receiving the UE-ID, the network node 110 transmits a message, i.e. Msg4, comprising the UE-ID settling the contention resolution. The message also comprises a Physical Uplink Shared Channel, PUSCH, grant occasion on UL PUSCH resources. This may be transmitted on the Physical Downlink Shared Channel, PDSCH.

Action 809. The wireless device 122 may then perform an UL data transmission on the granted PUSCH resources to the network node 110.

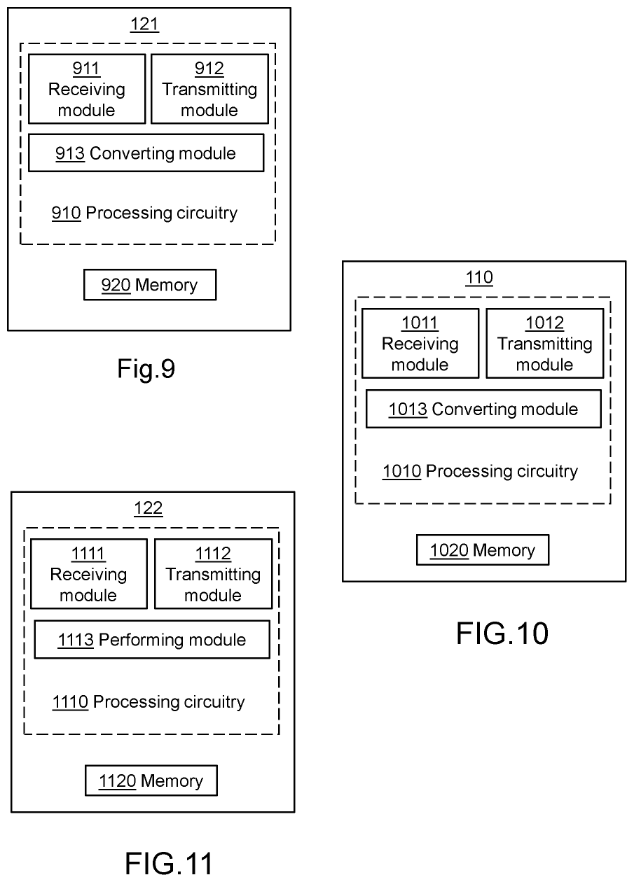

To perform the method actions in a coordinating wireless device 121 for enabling a group of wireless devices 131 to perform uplink, UL, transmissions towards a network node 110 in a wireless communications network 100, the coordinating wireless device 121 may comprise the following arrangement depicted in FIG. 9. FIG. 9 shows a schematic block diagram of embodiments of a coordinating wireless device 121. The embodiments of the coordinating wireless device 121 described herein may be considered as independent embodiments or may be considered in any combination with each other to describe non-limiting examples of the example embodiments described herein. It should also be noted that, although not shown in FIG. 9, it should be noted that known conventional features of a wireless device, such as, for example, at least one antenna and a power source, e.g. a battery, may be assumed to be comprised in the coordinating wireless device 121 but is not shown or described any further in regards to FIG. 9.

The coordinating wireless device 121 may comprise processing circuitry 910 and a memory 920. The processing circuitry 910 may also comprise a receiving module 911 and a transmitting module 912. The receiving module 911 and the transmitting module 912 may comprise Radio Frequency, RF, circuitry and baseband processing circuitry capable of transmitting and receiving a radio signal in the wireless communications network 100. The receiving module 911 and the transmitting module 912 may also form part of a single transceiver. It should also be noted that some or all of the functionality described in the embodiments above as being performed by the coordinating wireless device 121 may be provided by the processing circuitry 910 executing instructions stored on a computer-readable medium, such as, e.g. the memory 920 shown in FIG. 9. Alternative embodiments of the coordinating wireless device 121 may comprise additional components, such as, for example, a converting module 913, responsible for providing its functionality to support the embodiments described herein.

The coordinating wireless device 121 or processing circuitry 910 is configured to, or may comprise the receiving module 911 configured to, receive, from the network node 110, information configuring the coordinating wireless device 121 to handle Random Access, RA, using Sidelink, SL, resources towards wireless devices in the group of wireless devices 131. Also, the coordinating wireless device 121 or processing circuitry 910 is configured to, or may comprise the transmitting module 912 configured to, transmit, to the wireless devices in the group of wireless devices 131 on SL resources, information for use by the wireless devices 122, 123, 124 in the group of wireless devices 131 to perform RA using SL resources towards the coordinating wireless device 121. In some embodiments, the received information may comprise information indicating a set of temporary network identifiers, TC-RNTIs, to be assigned to wireless devices 122, 123, 124 in the group of wireless devices 131 by the coordinating wireless device 121 during RA.

In some embodiments, the coordinating wireless device 121 or processing circuitry 910 may be configured to, or may comprise the receiving module 911 configured to, receive a RA request from a wireless device 122 in the group of wireless devices 131 on SL resources. In this case, the coordinating wireless device 121 or processing circuitry 910 may also be configured to, or may comprise the transmitting module 911 configured to, transmit a Random Access Response, RAR, to the wireless device 122 in the group of wireless devices 131 on SL resources.

Optionally, according to some embodiments, the coordinating wireless device 121 or processing circuitry 910 may here also be configured to, or may comprise the transmitting module 911 configured to, transmit, to the network node 110, information indicating that the wireless device 122 has been assigned a temporary network identifier, TC-RNTI, for use by the wireless device 122 in an UL data transmission towards the network node 100 on Physical Uplink Shared Channel, PUSCH, resources granted by the coordinating wireless device 121. Furthermore, in some embodiments, the RAR may comprise information indicating a grant for the UL data transmission towards the network node 110 on the PUSCH resources and the assigned temporary network identifier, TC-RNTI.

Alternatively, according to some embodiments, the coordinating wireless device 121 or processing circuitry 910 may be configured to, or may comprise the receiving module 911 configured to, receive, from the wireless device 122 on SL resources, information indicating the identifier, UE-ID, of the wireless device 122. In this case, according to some embodiments, the coordinating wireless device 121 or processing circuitry 910 may also be configured to, or may comprise the transmitting module 911 configured to, transmit, to the wireless device 122 on SL resources, information indicating a grant for the UL data transmission towards the network node 110 on the PUSCH resources using the received identifier, UE-ID, of the wireless device 122. Further, in some embodiments, the coordinating wireless device 121 or processing circuitry 910 may also be configured to, or may comprise the converting module 913 configured to, convert the temporary network identifier, TC-RNTI, assigned to the wireless device 122 into a network identifier, C-RNTI, of the wireless device 122 in the wireless communication network 100. In some embodiments, the coordinating wireless device 121 or processing circuitry 910 may here also be configured to, or may comprise the transmitting module 911 configured to, transmit, to the network node 110, information indicating that the wireless device 122 has been provided with a grant for an UL data transmission towards the network node 100 on PUSCH resources, and information indicating a mapping of an identifier, UE-ID, of the wireless device 122 to a network identifier, C-RNTI, of the wireless device 122 in the wireless communication network 100. According to some embodiments, the RA request from the wireless device 122 may comprise a preamble specifically assigned to the wireless device 122 in the coordinating device 121. According to some embodiments, the RAR may comprise information indicating: a grant for transmitting the identifier, UE-ID, of the wireless device 122 to the coordinating wireless device 121 on SL resources, a temporary network identifier, TC-RNTI, assigned to the wireless device 122, and a Timing Advance, TA, of the coordinating wireless device 121.

In some embodiments, the coordinating wireless device 121 or processing circuitry 910 may also be configured to, or may comprise the transmitting module 911 configured to, transmit system information, such as, e.g. MIB and/or SIB, received from the network node 110 to the wireless devices 122, 123, 124 in the group of wireless devices 121, 122 periodically on SL resources.

Furthermore, the embodiments for enabling a group of wireless devices 131 to perform UL transmissions towards a network node 110 in a wireless communications network 100 described above may be implemented through one or more processors, such as the processing circuitry 910 in the coordinating wireless device 121 depicted in FIG. 9, together with computer program code for performing the functions and actions of the embodiments herein. The program code mentioned above may also be provided as a computer program product, for instance in the form of a data carrier carrying computer program code or code means for performing the embodiments herein when being loaded into the processing circuitry 910 in the coordinating wireless device 121. The computer program code may e.g. be provided as pure program code in the coordinating wireless device 121 or on a server and downloaded to the coordinating wireless device 121. Thus, it should be noted that the modules of the coordinating wireless device 121 may in some embodiments be implemented as computer programs stored in memory, e.g. in the memory modules 920 in FIG. 9, for execution by processors or processing modules, e.g. the processing circuitry 910 of FIG. 9.

To perform the method actions in a network node 110 for enabling a group of wireless devices 131 to perform uplink, UL, transmissions towards the network node 110 in a wireless communications network 100, the network node 110 may comprise the following arrangement depicted in FIG. 10. FIG. 10 shows a schematic block diagram of embodiments of a network node 110. The embodiments of the network node 110 described herein may be considered as independent embodiments or may be considered in any combination with each other to describe non-limiting examples of the example embodiments described herein. It should also be noted that, although not shown in FIG. 9, it should be noted that known conventional features of a network node, such as, for example, at least one antenna, a connection to a power source, e.g. an electric power grid, and a connection to the core network of the wireless communications network 100, may be assumed to be comprised in the network node 110 but is not shown or described any further in regards to FIG. 10.

The network node 110 may comprise processing circuitry 1010 and a memory 1020. The processing circuitry 1010 may also comprise a receiving module 1011 and a transmitting module 1012. The receiving module 1011 and the transmitting module 1012 may comprise Radio Frequency, RF, circuitry and baseband processing circuitry capable of transmitting and receiving a radio signal in the wireless communications network 100. The receiving module 1011 and the transmitting module 1012 may also form part of a single transceiver. It should also be noted that some or all of the functionality described in the embodiments above as being performed by the network node 110 may be provided by the processing circuitry 1010 executing instructions stored on a computer-readable medium, such as, e.g. the memory 1020 shown in FIG. 10. Alternative embodiments of the network node 110 may comprise additional components, such as, for example, a converting module 1013, responsible for providing its functionality to support the embodiments described herein.

The network node 110 or processing circuitry 1010 is configured to, or may comprise the transmitting module 1012 configured to, transmit, to a coordinating wireless device 121, information configuring the coordinating wireless device 121 to handle Random Access, RA, using Sidelink, SL, resources towards wireless devices in a group of wireless devices 131 associated with the coordinating wireless device 121. Also, the network node 110 or processing circuitry 1010 is configured to, or may comprise the transmitting module 1012 configured to, transmit, to the wireless devices 122, 123, 124 in the group of wireless devices 131, information configuring the wireless devices 122, 123, 124 in the group of wireless devices 131 to perform RA using SL resources towards the coordinating wireless device 121.

In some embodiments, the network node 110 or processing circuitry 1010 may be configured to, or may comprise the receiving module 1011 configured to, receive, from the coordinating wireless device 121, information indicating that a wireless device 122 in the group of wireless devices 131 has been assigned a temporary network identifier, TC-RNTI, for use by the wireless device 122 in an UL data transmission towards the network node 100 on Physical Uplink Shared Channel, PUSCH, resources granted by the coordinating wireless device 121. In this case, according to some embodiments, the network node 110 or processing circuitry 1010 may be configured to, or may comprise the receiving module 1011 configured to, receive, from the wireless device 122, information indicating the identifier, UE-ID, of the wireless device 122. Here, in some embodiments, the network node 110 or processing circuitry 1010 may be configured to, or may comprise the transmitting module 1012 configured to, transmit, to the wireless device 122, information indicating a grant for the UL data transmission towards the network node 110 on the PUSCH resources using the received identifier, UE-ID, of the wireless device 122. Further, the network node 110 or processing circuitry 1010 may here also be configured to, or may comprise the converting module 1013 configured to, convert the temporary network identifier, TC-RNTI, assigned to the wireless device 122 to a network identifier, C-RNTI, of the wireless device 122 in the wireless communication network 100.

Optionally, in some embodiments, the network node 110 or processing circuitry 1010 may be configured to, or may comprise the receiving module 1011 configured to, receive, from the coordinating wireless device 121, information indicating that a wireless device 122 in the group of wireless devices 131 has been provided with a grant for an UL data transmission towards the network node 100 on PUSCH resources, and information indicating a mapping of an identifier, UE-ID, of the wireless device 122 to a network identifier, C-RNTI, of the wireless device 122 in the wireless communication network 100. In some embodiments, the network node 110 or processing circuitry 1010 may be configured to, or may comprise the receiving module 1011 configured to, receive, from the wireless device 122, an UL data transmission on PUSCH resources.

Furthermore, the embodiments for enabling a group of wireless devices 131 to perform uplink, UL, transmissions towards the network node 110 in a wireless communications network 100 described above may be implemented through one or more processors, such as the processing circuitry 1010 in the network node 110 depicted in FIG. 10, together with computer program code for performing the functions and actions of the embodiments herein. The program code mentioned above may also be provided as a computer program product, for instance in the form of a data carrier carrying computer program code or code means for performing the embodiments herein when being loaded into the processing circuitry 1010 in the network node 110. The computer program code may e.g. be provided as pure program code in the network node 110 or on a server and downloaded to the network node 110. Thus, it should be noted that the modules of the network node 110 may in some embodiments be implemented as computer programs stored in memory, e.g. in the memory modules 1020 in FIG. 10, for execution by processors or processing modules, e.g. the processing circuitry 1010 of FIG. 10.

To perform the method actions in a wireless device 122 for enabling uplink, UL, transmissions towards a network node 110 in a wireless communications network 100, the wireless device 122 may comprise the following arrangement depicted in FIG. 11. FIG. 11 shows a schematic block diagram of embodiments of a wireless device 122. The embodiments of the wireless device 122 described herein may be considered as independent embodiments or may be considered in any combination with each other to describe non-limiting examples of the example embodiments described herein. It should also be noted that, although not shown in FIG. 11, it should be noted that known conventional features of a wireless device, such as, for example, at least one antenna and a power source, e.g. a battery, may be assumed to be comprised in the wireless device 122 but is not shown or described any further in regards to FIG. 11.

The wireless device 122 may comprise processing circuitry 1110 and a memory 1120. The processing circuitry 1110 may also comprise a receiving module 1111 and a transmitting module 1112. The receiving module 1111 and the transmitting module 1112 may comprise Radio Frequency, RF, circuitry and baseband processing circuitry capable of transmitting and receiving a radio signal in the wireless communications network 100. The receiving module 1111 and the transmitting module 1112 may also form part of a single transceiver. It should also be noted that some or all of the functionality described in the embodiments above as being performed by the wireless device 122 may be provided by the processing circuitry 1110 executing instructions stored on a computer-readable medium, such as, e.g. the memory 1120 shown in FIG. 11. Alternative embodiments of the wireless device 122 may comprise additional components, such as, for example, a performing module 1113, responsible for providing its functionality to support the embodiments described herein.

The wireless device 122 or processing circuitry 1110 is configured to, or may comprise the receiving module 1111 configured to, receive, from the network node 110, information configuring the wireless device 122 to perform Random Access, RA, using Sidelink, SL, resources towards a coordinating wireless device 121 associated with the wireless device 122. Also, the wireless device 122 or processing circuitry 1110 is configured to, or may comprise the receiving module 1111 configured to, receive, from the coordinating wireless device 121 on SL resources, information for use by the wireless device 122 to perform RA using SL resources towards the coordinating wireless device 121.

In some embodiments, the wireless device 122 or processing circuitry 1110 may be configured to, or may comprise the transmitting module 1112 configured to, transmit a RA request to the coordinating wireless device 121 on SL resources; and receive a Random Access Response, RAR, from the coordinating wireless device 121 on SL resources. Here, according to some embodiments, in case the RAR comprise information indicating a grant for the UL data transmission towards the network node 110 on the PUSCH resources and an assigned temporary network identifier, TC-RNTI, the wireless device 122 or processing circuitry 1110 may be configured to, or may comprise the transmitting module 1112 configured to, transmit, to the network node 110, information indicating the identifier, UE-ID, of the wireless device 122. Also, in some embodiments, the wireless device 122 or processing circuitry 1110 may be configured to, or may comprise the receiving module 1111 configured to, receive, from the network node 110, information indicating a grant for the UL data transmission towards the network node 110 on the PUSCH resources using the received identifier, UE-ID, of the wireless device 122.

Optionally, according to some embodiments, in case the RAR comprise: a grant for transmitting the identifier, UE-ID, of the wireless device 122 to the coordinating wireless device 121 on SL resources, a temporary network identifier TC-RNTI) assigned to the wireless device 122, and a Timing Advance, TA, of the coordinating wireless device 121, the wireless device 122 or processing circuitry 1110 may be configured to, or may comprise the transmitting module 1112 configured to, transmit, to the coordinating wireless device 121 on SL resources, information indicating the identifier, UE-ID, of the wireless device 122. Here, in some embodiments, the wireless device 122 or processing circuitry 1110 may also be configured to, or may comprise the receiving module 1111 configured to, receive, from the coordinating wireless device 121 on SL resources, information indicating a grant for the UL data transmission towards the network node 110 on the PUSCH resources using the received identifier, UE-ID, of the wireless device 122.

In some embodiments, the wireless device 122 or processing circuitry 1110 may be configured to, or may comprise the performing module 1113 configured to, perform, to the network node 110, an UL transmission on PUSCH resources.

Furthermore, the embodiments for enabling uplink, UL, transmissions towards a network node 110 in a wireless communications network 100 described above may be implemented through one or more processors, such as the processing circuitry 1110 in the wireless device 122 depicted in FIG. 11, together with computer program code for performing the functions and actions of the embodiments herein. The program code mentioned above may also be provided as a computer program product, for instance in the form of a data carrier carrying computer program code or code means for performing the embodiments herein when being loaded into the processing circuitry 1110 in the wireless device 122. The computer program code may e.g. be provided as pure program code in the wireless device 122 or on a server and downloaded to the wireless device 122. Thus, it should be noted that the modules of the wireless device 122 may in some embodiments be implemented as computer programs stored in memory, e.g. in the memory modules 1120 in FIG. 11, for execution by processors or processing modules, e.g. the processing circuitry 1110 of FIG. 11.

Those skilled in the art will also appreciate that the processing circuitries 910, 1010, 1110 and the memories 920, 1020, 1120 described above may refer to a combination of analog and digital circuits, and/or one or more processors configured with software and/or firmware, e.g. stored in a memory, that when executed by the one or more processors such as the processing circuitries 910, 1010, 1110 perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

It should also be noted that the various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The embodiments herein are not limited to the above described preferred embodiments. Various alternatives, modifications and equivalents may be used. Therefore, the above embodiments should not be construed as limiting.

### Abbreviations

CG Configured Grant
ACK Acknowledgment
NACK Negative Acknowledgement
RV Redundancy Version
SG Scheduling Grant
DCI Downlink Control Information
MAC Media Access Control
CE Control element
TO Transmission Occasion
LCH Logical Channel
LCG Logical Channel Group
LBT Listen-Before-Talk
CCA Clear Channel Assessment
RSRP Reference Signal Received Power
RSSI Received Signal Strength Indicator
RSRQ Reference Signal Received Quality
SI System Information
MCS Modulation and Coding Scheme
UCI Uplink Control Information
PUCCH Physical Uplink Control Channel
PUSCH Physical Uplink Shared Channel
RRC Radio Resource Control
IE Information Element
SLIV Start and Length Indicator Value
RI Rank Indicator
PMI Precoding Matrix Indicator
UE User Equipment
gNB gNodeB
5G Fifth Generation
HARQ Hybrid Automatic Repeat Request
SRI Sounding Reference Signals (SRS) Resource Indicator
QOS Quality of Service
BWP Bandwidth Part
CGT configuredGrantTimer
CGRT configuredGrantRetransmission Timer
DFI Downlink Feedback Information
SCS Sub-Carrier Spacing
OFDM Orthogonal Frequency-Division Multiplexing
CP Cyclic Prefix
D2D Device-to-Device
DL Downlink
ONB evolved NodeB
LTE Long Term Evolution
SL SideLink
UL Uplink
TX Transmission
RX Reception

1-45. (canceled)

46. A method of enabling a group of wireless devices to perform uplink (UL) transmissions towards a network node in a wireless communications network, performed by a coordinating wireless device, the method comprising:
receiving, from the network node, information configuring the coordinating wireless device to handle Random Access (RA) using Sidelink (SL) resources towards wireless devices in the group of wireless devices; and
transmitting, to the wireless devices in the group of wireless devices on SL resources, information for use by the wireless devices in the group of wireless devices to perform RA using SL resources towards the coordinating wireless device.

47. The method of claim 46, wherein the received information comprises information indicating a set of Temporary Cell Radio Network Temporary Identifiers (TC-RNTIs) to be assigned to wireless devices in the group of wireless devices by the coordinating wireless device during RA.

48. The method of claim 46, further comprising:
receiving a RA request from a wireless device in the group of wireless devices on SL resources; and
transmitting a Random Access Response (RAR) to the wireless device in the group of wireless devices on SL resources.

49. The method of claim 48, further comprising transmitting, to the network node, information indicating that the wireless device has been assigned a TC-RNTI for use by the wireless device in an UL data transmission towards the network node on Physical Uplink Shared Channel (PUSCH) resources granted by the coordinating wireless device.

50. The method of claim 49, wherein the RAR comprises information indicating a grant for the UL data transmission towards the network node on the PUSCH resources and the TC-RNTI.

51. The method of claim 49, further comprising:
receiving, from the wireless device on SL resources, information indicating a User Equipment Identifier (UE-ID) of the wireless device;
transmitting, to the wireless device on SL resources, information indicating a grant for the UL data transmission towards the network node on the PUSCH resources using the UE-ID; and
converting the TC-RNTI assigned to the wireless device to a Cell Radio Network Temporary Identifier (C-RNTI) of the wireless device in the wireless communication network.

52. The method of claim 51, further comprising transmitting, to the network node:
information indicating that the wireless device has been provided with a grant for an UL data transmission towards the network node on PUSCH resources; and
information indicating a mapping of the UE-ID to the C-RNTI.

53. The method of claim 51, wherein the RA request from the wireless device comprises a preamble specifically assigned to the wireless device in the coordinating wireless device.

54. The method of claim 51, wherein the RAR comprises information indicating:
a grant for transmitting the UE-ID to the coordinating wireless device on SL resources;
the TC-RNTI assigned to the wireless device; and
a timing advance of the coordinating wireless device.

55. The method of claim 46, wherein the transmitting further comprises transmitting system information received from the network node to the wireless devices in the group of wireless devices periodically on SL resources.

56. A coordinating wireless device operative to enable a group of wireless devices to perform uplink (UL) transmissions towards a network node in a wireless communications network, the coordinating wireless device comprising:
processing circuitry and memory circuitry, the memory circuitry storing instructions executable by the processing circuitry whereby the coordinating wireless device is configured to:
receive, from the network node, information configuring the coordinating wireless device to handle Random Access (RA) using Sidelink (SL) resources towards wireless devices in the group of wireless devices; and
transmit, to the wireless devices in the group of wireless devices on SL resources, information for use by the wireless devices in the group of wireless devices to perform RA using SL resources towards the coordinating wireless device.

57. The coordinating wireless device of claim 56, wherein the received information comprises information indicating a set of Temporary Cell Radio Network Temporary Identifiers (TC-RNTIs) to be assigned to wireless devices in the group of wireless devices by the coordinating wireless device during RA.

58. The coordinating wireless device of claim 56, further configured to:
receive a RA request from a wireless device in the group of wireless devices on SL resources; and
transmit a Random Access Response (RAR) to the wireless device in the group of wireless devices on SL resources.

59. The coordinating wireless device of claim 58, further configured to transmit, to the network node, information indicating that the wireless device has been assigned a TC-RNTI for use by the wireless device in an UL data transmission towards the network node on Physical Uplink Shared Channel (PUSCH) resources granted by the coordinating wireless device.

60. The coordinating wireless device of claim 59, wherein the RAR comprises information indicating a grant for the UL data transmission towards the network node on the PUSCH resources and the TC-RNTI.

61. The coordinating wireless device of claim 59, further configured to:
receive, from the wireless device on SL resources, information indicating a User Equipment Identifier (UE-ID) of the wireless device;
transmit, to the wireless device on SL resources, information indicating a grant for the UL data transmission towards the network node on the PUSCH resources using the UE-ID; and
convert the TC-RNTI assigned to the wireless device to a Cell Radio Network Temporary Identifier (C-RNTI) of the wireless device in the wireless communication network.

62. The coordinating wireless device of claim 61, further configured to transmit, to the network node:
information indicating that the wireless device has been provided with a grant for an UL data transmission towards the network node on PUSCH resources; and
information indicating a mapping of the UE-ID to the C-RNTI.

63. The coordinating wireless device of claim 61, wherein the RA request from the wireless device comprises a preamble specifically assigned to the wireless device in the coordinating wireless device.

64. The coordinating wireless device of claim 61, wherein the RAR comprises information indicating:
a grant for transmitting the UE-ID to the coordinating wireless device on SL resources;
the TC-RNTI assigned to the wireless device; and
a timing advance of the coordinating wireless device.

65. The coordinating wireless device of claim 56, wherein to transmit the information for use by the wireless devices, the coordinating wireless device is further configured to transmit system information received from the network node to the wireless devices in the group of wireless devices periodically on SL resources.
